(19) United States
(12) Patent Application Publication
(10) Pub. No.: US 2023/0236012 A1
(43) Pub. Date: Jul. 27, 2023

(54) DRAFT INFORMATION GENERATION DEVICE AND DRAFT INFORMATION GENERATION METHOD

(71) Applicant: FURUNO ELECTRIC CO., LTD., Hyogo-Pref. (JP)

(72) Inventor: Hiroyuki BAJI, Takarazuka (JP)

(73) Assignee: FURUNO ELECTRIC CO., LTD., Hyogo-Pref. (JP)

(21) Appl. No.: 18/194,375

(22) Filed: Mar. 31, 2023

Related U.S. Application Data
(63) Continuation-in-part of application No. PCT/JP2021/032857, filed on Sep. 7, 2021.

(30) Foreign Application Priority Data
Oct. 7, 2020 (JP) 2020-169838

(51) Int. Cl. G01C 3/20; B63B 39/12; B63B 79/10

(52) U.S. Cl. CPC G01C 3/20; B63B 39/12; B63B 79/10

(57) ABSTRACT

The purpose of this disclosure is to easily calculate draft information with a simple configuration. The draft information generation device (10) comprises multiple range-finding sensors (20) and an information processor module (30). The range-finding sensor (20) is mounted on the side of a vessel (80) and measures the distance to water surface (91) using a range-finding signal. The information processor module (30) calculates draft height Hdr using the distance to the water surface (91) and the mold depth Hmd of the vessel (80).

### CROSS-REFERENCE TO RELATED APPLICATION(S)

This application is a continuation-in-part of PCT International Application No. PCT/JP2021/032857, which was filed on Sep. 7, 2021, and which claims priority to Japanese Patent Application No. 2020-169838 filed on Oct. 7, 2020, the entire disclosures of each of which are herein incorporated by reference for all purposes.

### TECHNICAL FIELD

The present disclosure relates to a draft information generation device and a draft information generating method for generating draft information of draft height and wave height.

### BACKGROUND ART

A Japanese Patent Publication No. JPH06-293291A describes a draft measuring device for a ship. The draft measuring device is equipped with a plurality of ultrasonic transmitter-receiver elements arranged at the bottom of a water channel and a water level gauge. Ultrasound transmitted and received by multiple ultrasonic transmitter-receiver elements measures the distance from the bottom of the vessel to the bottom of the channel, and from this distance and the water level measured by the water level gauge, the draft value is calculated. However, the configuration for measuring draft height becomes large.

Another Japanese Patent Publication No. JP2014-196056A describes a draft measuring instrument. The draft measuring instrument has a water level detection sensor housed in a cylindrical member. The measurement of water level by the draft measuring instrument is carried out with the measuring instrument installed on the draft mark of the ship, etc. The draft value (draft height) is calculated from the measured water level and the value indicated by the draft mark. Since a measurer approaches the vessel to perform the measurement, the measurer is necessary and the work involves a risk of danger.

### DESCRIPTION OF THE DISCLOSURE

### Problem(s) to be Solved by the Disclosure

An object of the present disclosure is to calculate draft information without any effort and without using a large scale configuration.

### SUMMARY

A draft information generation device according to the present disclosure includes a range-finding sensor and an information processor module. The range-finding sensor is mounted on a side of a vessel and measures a distance to a water surface by transmitting a range-finding signal. The information processor module calculates a draft height based on the distance to the water surface. There are a plurality of the range-finding sensors being mounted at different positions on the vessel. The different positions of the vessel include a bow of the vessel, a stern of the vessel, and a longitudinal middle of the vessel. The plurality of range-finding sensors measure the distance at multiple times and the information processor module calculates the draft height using a statistical value of the distance measured at the multiple times. The information processor module also includes a data selector and a data generator. The data selector selects the distance measured at the multiple times based on the intensity of the range-finding signal. The data generator executes a prescribed interpolation processing for the selected distance to generate data for calculation of the draft height consisting of distances arranged in time series. The information processor module also includes a frequency component detector. The frequency component detector detects a frequency component of the distance measured at the multiple times, and the data generator also executes the interpolation processing using the frequency components. A draft information generation method and program configured to cause a processing unit to execute processing, the processing according to the present disclosure includes measuring a distance to a water surface from a predetermined position above the water surface of a hull by using a range-finding signal, and calculating a draft height based on the distance to the water surface. The processing according to the present disclosure also includes measuring the distance at different positions on the vessel. The processing according to the present disclosure also includes measuring the distance at multiple times and calculating the draft height using a statistical value of the distance measured at the multiple times. The processing according to the present disclosure also includes selecting the distance measured at the multiple times based on the intensity of the range-finding signal and executing a prescribed interpolation processing for the selected distance to generate data for calculation of the draft height consisting of distances arranged in time series. The processing according to the present disclosure also includes detecting a frequency component of the distance measured at the above multiple times and executing the interpolation processing using the frequency components.

In accordance with an embodiment, a first aspect of the present disclosure relates to a draft information generation device. The draft information generation device, according to the present embodiment, is equipped with a plurality of range-finding sensors and an information processor module. The plurality of range-finding sensors are mounted on the side of a vessel to measure the distance to a water surface using range-finding signals. An information processor module calculates draft height based on the distance to the water surface.

According to this configuration, the draft height is calculated simply by measuring the distance to the water surface by the range-finding sensor mounted on the vessel without the need for a gauger.

According to this disclosure, the draft information can be easily calculated with a simple configuration.

The effect or significance of the present disclosure will become more apparent from the description of the following embodiments. However, the following embodiments are only examples of the present disclosure, and the present disclosure is not limited in any way to those described in the following embodiments described below.

### BRIEF DESCRIPTION OF DRAWINGS

FIG. 1 is an example of an arrangement of range-finding sensors, according to an embodiment;

FIG. 2 is an enlarged view of the positioning of the range-finding sensors, according to an embodiment;

FIG. 3 is a functional block diagram showing an example of the configuration of a draft information generation device, according to an embodiment;

FIG. 4 is a functional block diagram showing an example of the configuration of the draft information generation device, according to an embodiment;

FIG. 5 is a graph showing distribution of distances based on signal strength, an example of selected data (distance), and an example of data for calculation (distance), according to an embodiment;

FIG. 6 is a flow chart showing an example of a draft information generation method, according to an embodiment;

FIG. 7 is a functional block diagram showing an example of the configuration of the draft information generation device according to a second embodiment, according to an embodiment;

FIG. 8 is a functional block diagram showing an example of the configuration of the draft information generation device according to a third embodiment, according to an embodiment.

### DETAILED DESCRIPTION

Embodiments of the present disclosure will now be described with reference to the drawings. The following embodiment shows an example in which the present disclosure is applied to a target detection device installed on the hull of a fishing boat or the like. However, the following embodiment is one embodiment of the present disclosure, and the present disclosure is not limited in any way to the following embodiments.

A draft information generation technique according to a first embodiment of the present disclosure will be described with reference to the figures.

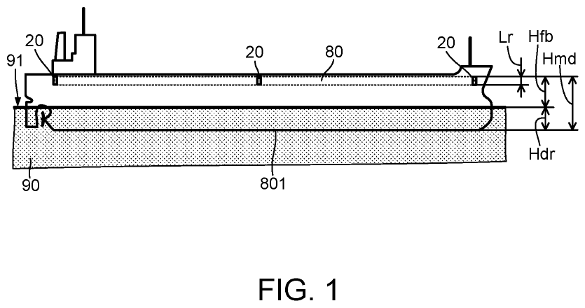

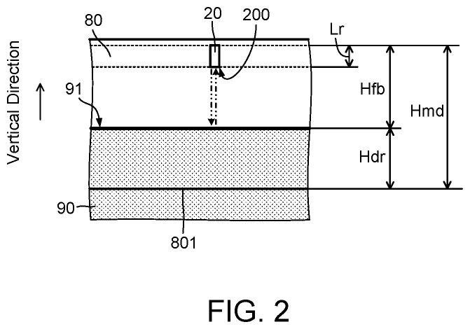

FIG. 1 is an example of an arrangement of multiple range-finding sensors (20). FIG. 2 is an enlarged view of the positioning of the multiple range-finding sensors (20). As shown in FIG. 1, multiple range-finding sensors (20) are mounted on the hull of a vessel (80).

According to this arrangement, the multiple range-finding sensors (20) corresponds to a plurality of range-finding sensors. In one example, the multiple range-finding sensors (20) are mounted at a center of a bow and a stern of the vessel (80) and the longitudinal direction of the vessel (80) on the starboard side of the vessel (80). It can be noted that the longitudinal direction corresponds to direction connecting the bow and the stern.

According to the first embodiment, a bow position is a position near the bow, a stern position is a position near the stern, and a middle position is a position near the middle. Therefore, the multiple range-finding sensors (20) are arranged at different positions in the longitudinal direction of the vessel (80).

The location of the multiple range-finding sensors (20) is not limited to these locations. In addition, at least one range-finding sensor needs to be mounted on the vessel (80). When there is only one range-finding sensor, it is preferable to set the position where the draft height causes the change, for example, the position where the loads in the vessel (80) overlap in the longitudinal direction of the vessel (80).

As shown by double-dotted dashed arrows in FIG. 2, the multiple range-finding sensors (20) are mounted on the vessel (80) so that the transmitted range-finding signal can be reflected from water surface (91) and the reflected signal can be received. Furthermore, the multiple range-finding sensors (20) are arranged on the vessel (80) so that a transmission/reception surface (200) of the range-finding signal is perpendicular to the vertical direction.

In an embodiment, when the vessel (80) is in still water, or without wobbling, the multiple range-finding sensors (20) are arranged so that the transmission/reception surface (200) is perpendicular to the vertical direction.

In an implementation, the multiple range-finding sensors (20) are installed near the deck in the vertical direction in other words, not in sea (water body) (90). In an ordinary implementation, the multiple range-finding sensors (20) are installed near the deck in the vertical direction not below the water surface (91). Furthermore, the multiple range-finding sensors (20) are preferably mounted to match reference position on an upper side of a freeboard (opposite to the water surface (91)) and the reference position on the upper side of a mold depth.

The multiple range-finding sensors (20) transmit a range-finding signal toward the water surface (91). The multiple range-finding sensors (20) receive the reflected range-finding signal at the water surface (91). For example, the range-finding signal is laser light. The range-finding signal may be of another type as long as it is highly linear and reflects at the water surface (91).

The multiple range-finding sensors (20) calculates the distance from the range-finding sensor to the water surface (91) from time difference between a time of transmission and a time of reception. More specifically, the multiple range-finding sensors (20) calculates the distance from a transmission/reception surface (200) of the multiple range-finding sensors (20) to the water surface (91). For example, the multiple range-finding sensors (20) calculates the difference between the transmission time and the reception time of the range-finding signal and multiplies the difference by ½ to calculate the distance.

The multiple range-finding sensors (20) perform ranging at multiple times. It can be noted that the multiple range-finding sensors (20) may perform range-finding only once, therefore it is preferable to perform range-finding at multiple times because of the processing, which is described later.

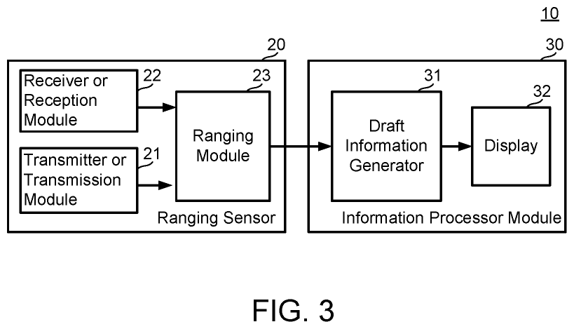

FIG. 3 is a functional block diagram showing an example of the configuration of a draft information generation device (10), according to the first embodiment. FIG. 3 shows the case of a single range-finding sensor.

As shown in FIG. 3, the draft information generation device (10) includes a range-finding sensor and an information processor module (30). The information processor module (30) is arranged on the deck of the vessel (80). The range-finding sensor and the information processor module (30) are connected by wired or wireless communication. When there are multiple range-finding sensors (20), each of the range-finding sensor is connected to the information processor module (30) by a prescribed communication format.

The range-finding sensor includes a transmitter (21), a receiver (22), and a ranging module (23). The transmitter (21) generates and transmits the range-finding signal, as described above. The transmitter (21) may correspond to a transmission module. The transmitter (21) also outputs the transmission time to the ranging module (23). The receiver (22) receives the range-finding signal reflected by the water surface (91) and detects its signal level (amplitude). The receiver (22) outputs the signal level and reception time to the ranging module (23). The receiver (22) corresponds to a reception module.

The ranging module (23) calculates the distance from the difference between the transmission time and the reception time, as described above. The ranging module (23) outputs the distance to the information processor module (30). At this time, the ranging module (23) outputs the signal level associated with the distance.

The information processor module (30) includes a draft information generator (31) and a display (32). The draft information generator (31) can be realized by an arithmetic processing unit or processing circuitry such as a personal computer or a dedicated electronic circuit. The draft information generator (31) generates draft information of the draft level from the statistical value of the distance and outputs it to the display (32).

The display (32) is realized by, for example, a liquid crystal display and displays draft information. The information processor module (30) may be provided with various notification interface and external output interface instead of the display (32). The notification interface is, for example, a voice notification such as a speaker, and the external output interface is, for example, an interface for information communication to the network. A notification interface or an external output interface may be provided along with the display (32). The display (32) and the notification interface may be separate from the information processor module (30).

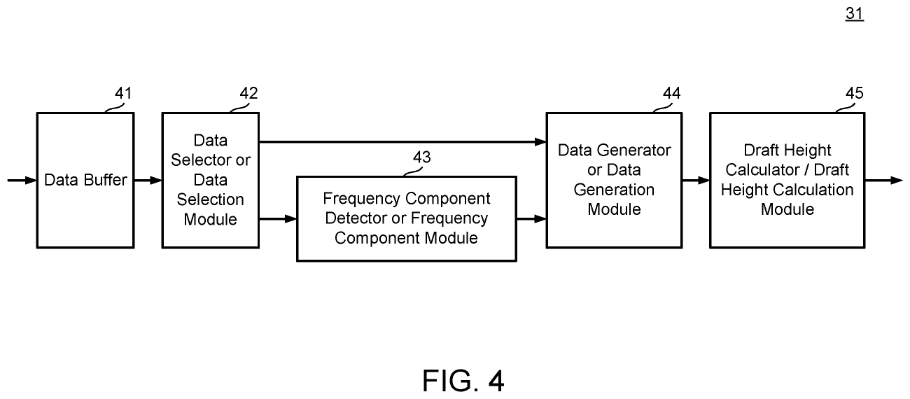

FIG. 4 is a functional block diagram showing an example of the configuration of the draft information generation device (10). As shown in FIG. 4, the draft information generator (31) includes a data buffer (41), a data selector (42), a frequency component detector (43), a data generator (44), and a draft height calculator (45).

Distance and signal level are input to the data buffer (41) from the range-finding sensor. The data buffer (41) stores distances and signal levels for multiple times. The data buffer (41) outputs the distance and signal level of multiple times over a predetermined time to the data selector (42).

The data selector (42) selects data by referring to the signal level. The data selector (42) corresponds to a data selection module. More specifically, data (distance) whose signal level falls within a predetermined range is selected and data (distance) that falls outside the predetermined range is excluded. The data selector (42) outputs the selection data (distance) to the frequency component detector (43) and the data generator (44). The frequency component detector (43) may correspond to a frequency component module.

It can be noted that the prescribed range is set by the range of signal levels effective for calculating the distance. In one example, the range is set to a range of signal levels obtained under the still water condition or when there is no wave between upper and lower limits of the measured range of draft height, calculated in advance, and given a predetermined margin. In another example, a reference range is set by the signal level under the still water condition when the draft height is at the upper end of the measurement range and the signal level under the still water condition when the draft height is at the lower end of the measurement range, and the range of the above signal level is set by having a predetermined margin for this reference range.

The frequency component detector (43) performs frequency analysis on a plurality of selected data (distances) arranged in a time series and detects a frequency component. By performing this processing, the frequency component detector (43) can detect the frequency of the wave for the multiple selected data (distances) arranged in time series. The frequency component detector 43 outputs the detected frequency to the data generator 44.

The data generator (44) may correspond to a data generation module. The data generator (44) generates data for calculating the draft height using the selection data (distance) arranged in time series and the frequency of the selection data (wave frequency) arranged in time series. More specifically, the data generator 44 interpolates time data (distance) not included in the selection data (distance) arranged in time series using the frequency component. This interpolation can be realized, for example, by using a nonlinear least squares method using frequencies. Therefore, the data for calculation of draft height (distance) consists of selection data (distance) arranged in time series and interpolated data for the time when these selection data do not exist. For example, the interpolated data includes data interpolated between adjacent selected data on the time axis.

The draft height calculator (45) may correspond to a draft height calculation module. The draft height calculator (45) calculates the draft height from data (distance) for calculating the draft height. More specifically, the draft height calculator (45) averages the calculation data (distance) for multiple hours to calculate a freeboard height Hfb. For example, in the examples of FIGS. 1 and 2, the upper end of the range-finding sensor coincides with the upper end of the freeboard height Hfb. Therefore, the draft height calculator (45) calculates the freeboard height Hfb by adding the length Lr (length in the vertical direction) of the range-finding sensor to the average value of the calculation data (distance). If the transmission/reception surface (200) coincides with the reference point at the upper end of the freeboard height Hfb, the process of adding the length Lr of the range-finding sensor can be omitted.

Then, as shown in FIGS. 1 and 2, the draft height calculator (45) calculates draft height Hdr, which is the distance between the water surface (91) and the ship bottom (801) in the vertical direction, by subtracting the freeboard height Hfb from the previously stored mold depth Hmd. If the position of the upper end of the mold depth Hmd in the vertical direction is different from the position of the reference point of the upper end of the freeboard height Hfb, correction may be made to offset the difference.

The draft height calculator (45) may calculate the freeboard height Hfb and the draft height Hdr at each time and calculate the draft height Hdr for multiple hours individually. In addition, the draft height calculator (45) may average the draft height Hdr of the multiple hours to make the final draft height Hdr.

Since the multiple range-finding sensors (20) are mounted on the vessel (80), the draft height can be calculated regardless of the location of the vessel (80). That is, it is not necessary to move the vessel (80) to calculate the draft height, and the draft height can be calculated on the spot when necessary.

Thus, the draft information generation device (10) can easily calculate draft information including draft height with a simple configuration. In addition, the draft information generation device (10) can calculate draft height with high precision for the following reasons.

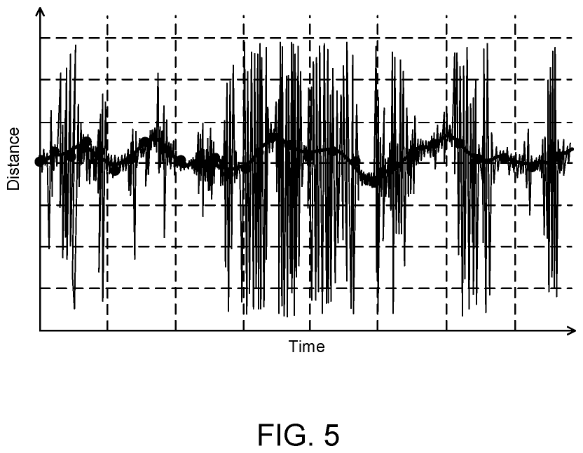

FIG. 5 is a graph showing the distribution of distances based on signal strength, an example of selected data (distance), and an example of data for calculation (distance).

The water surface (91) usually has various and sometimes irregular ruggedness instead of a uniform plane. In particular, when waves are present, the water surface (91) cannot be a uniform plane. For this reason, the reflection direction of the range-finding signal is not uniform and does not necessarily reflect in the direction perpendicular to the water surface (91).

Therefore, the signal levels of the received range-finding signals vary widely, and the distances calculated using this signal strength also vary widely.

However, by using the configuration of the draft information generation device (10), as described above, the received signal (received range-finding signal) used for the data for calculating the draft height is selected with reference to the signal level so as to suppress the effect of the above variation (see the black circle mark in FIG. 5). This improves the accuracy of the calculation of draft height.

Furthermore, by using the configuration of the draft information generation device (10) described above, the data (distance) at the time when there is no data on the time axis is interpolated by selecting the data (distance). The draft height is then calculated from the interpolated data. This improves the accuracy of calculating draft height.

Moreover, the interpolation is done by the frequency of the wave. Thus, the data for calculating the draft height includes the frequency component of the wave, as shown by the thick solid line in FIG. 5. Therefore, the calculated draft height more accurately reflects the wave condition, and the calculation accuracy of the draft height is further improved. That is, the draft information generation device (10) can calculate draft height with higher accuracy.

Moreover, by performing interpolation using such wave frequencies, the draft information generator (31) can calculate not only the draft height but also the wave height and the time change of the wave height as a kind of draft information. Then, by performing interpolation using the wave frequency, the draft information generator (31) can calculate the wave height and the change in the wave height over time with high precision.

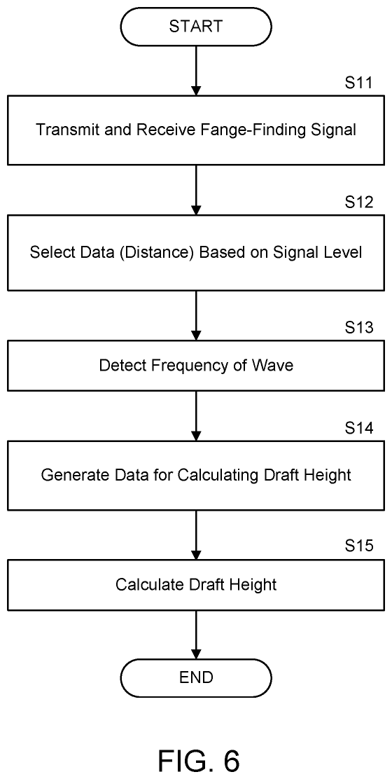

FIG. 6 is a flow chart showing an example of the draft information generation method. For example, the draft information generation method can be realized by programming the draft information generation method, shown in FIG. 6, storing it in a storage medium or the like, and executing this program by an arithmetic processing device such as a CPU. The specific details of each treatment are described in the description of the draft information generation device (10) described above, and descriptions are omitted except where additions are necessary.

The draft information generation device 10 transmits and receives the range-finding signal, at step (S11) and calculates data (distance). The draft information generation device (10) selects data (distance) based on the signal level, at step (S12). The draft information generation device (10) detects the frequency of the wave from the selected data (distance), at step (S13).

Using the selected data (distance) and wave frequency, the draft information generation device (10) interpolates the data (distance) to generate data for calculating the draft height, at step (S14).

The draft information generation device (10) calculates the draft height using the data for calculating the draft height, at step (S15).

By using such a draft information generation method, the draft information generation device (10) can easily calculate draft information including draft height with a simple configuration.

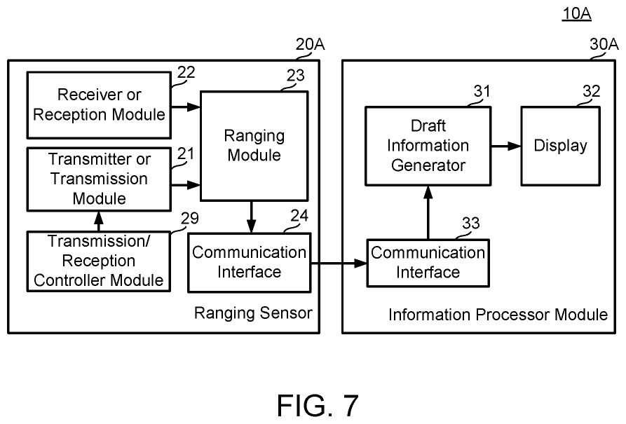

A draft information generation technique according to a second embodiment of the present disclosure will be described with reference to the figures. FIG. 7 is a functional block diagram showing an example of the configuration of the draft information generation device according to the second embodiment. FIG. 7 shows the case of a single range-finding sensor.

As shown in FIG. 7, a draft information generation device (10A) according to the second embodiment differs from the draft information generation device (10) according to the first embodiment in that a more specific configuration for communication and a transmission/reception controller module (29) for range-finding signals are added. The other configuration of the draft information generation device 10A is the same as that of the draft information generation device (10), and each description of the similar modules is omitted.

The draft information generation device (10A) is equipped with a range-finding sensor (20A) and an information processor module (30A).

The range-finding sensor (20A) includes the transmitter (21), the receiver (22), the ranging module (23), the communication interface (24), and the transmission/reception controller module (29). The transmission/reception controller module (29) controls the transmission time of the range-finding signal in the transmitter (21). The communication interface (24) converts the data (distance) and signal level calculated by the ranging module (23) into communication data of a prescribed system and transmits the data.

An information processor module (30A) includes the draft information generator (31), the display (32), and the communication interface (33). The communication interface (33) receives the communication data from the communication interface (24), demodulates the data (distance) and signal level, and outputs them to the draft information generator (31).

With such a configuration, for example, the draft information generation device (10A) can control the timing of ranging for calculating the draft height in more detail by providing the transmission/reception controller module (29).

Also, by providing the communication interface (24) and the communication interface (33), the format that can be adopted for data communication between the range-finding sensor (20A) and the information processor module (30A) can be increased.

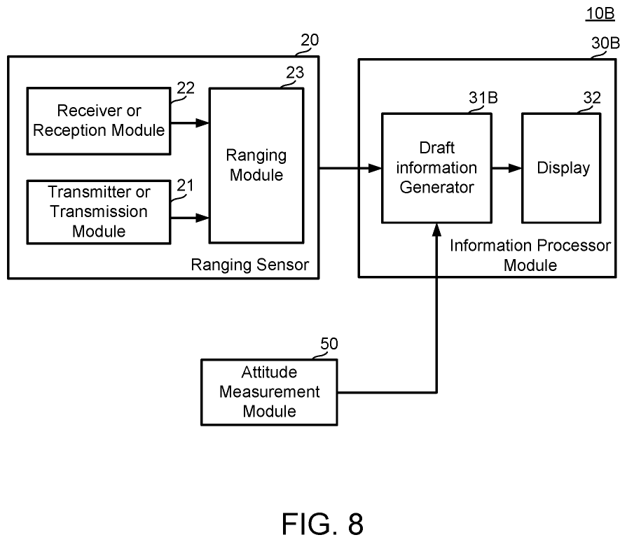

A draft information generation technique according to a third embodiment of the present disclosure will be described with reference to the figures. FIG. 8 is a functional block diagram showing an example of the configuration of a draft information generation device (10B), according to the third embodiment. FIG. 8 shows the case of a single range-finding sensor.

As shown in FIG. 8, the draft information generation device (10B) according to the third embodiment differs from the draft information generation device (10) according to the first embodiment in the point of having an altitude measurement module (50) and in the treatment of a draft information generator (31B). The other configuration of the draft information generation device (10B) is the same as that of the draft information generation device (10), and each description of the similar modules is omitted.

The draft information generation device (10B) is equipped with the range-finding sensor, an information processor module (30B), and the altitude measurement module (50). The information processor module (30B) includes the draft information generator (31B) and the display (32).

The altitude measurement module (50) measures the altitude of the vessel (80). The altitude measurement module (50) can be realized by, for example, an inertial sensor or a sensor using a positioning signal such as a GPS signal. The altitude measurement module 50 outputs the measured altitude to a draft information generation device module (31B).

The draft information generator (31B) corrects the data (distance) from the range-finding sensor (20) according to the altitude. For example, the draft information generator (31B) calculates, from the altitude, the angle between the direction perpendicular to the transmission/reception surface (200) of the range-finding sensor (20) and the water surface (91). The draft information generator (31B) stores the distance error due to this angle in advance, and corrects the data (distance) to cancel the distance error. Thus, the draft information generator (31B) can suppress the effect of the altitude of the vessel (80) and calculate the draft height with higher accuracy.

When selecting the data (distance), the draft information generator (31B) may correct the signal level according to the altitude and select the data (distance) using the corrected signal level. For example, the draft information generator (31B) calculates, from the altitude, the angle between the direction perpendicular to the transmission/reception surface (200) of the range-finding sensor and the water surface (91). The draft information generator (31B) stores the error of the signal level due to this angle in advance, and corrects the signal level to cancel the error of the signal level. Then, the draft information generator (31) uses the corrected signal level to select data (distance). Thus, the draft information generator (31B) can suppress the effect of the altitude of the vessel (80) and calculate the draft height with higher accuracy.

In the above explanation, the case of 1 range-finding sensor is mainly shown. However, when multiple range-finding sensors (20) are used, the draft information generation device (10) may calculate the draft height for each range-finding sensor 20, or the draft height may be calculated from the average value of the distances calculated by the multiple range-finding sensors (20). When the draft height is calculated for each range-finding sensor, the draft information generation device (10) can calculate the draft height according to the position of the vessel 80. When the average of the distances of multiple range-finding sensors (20) is used, the draft information generation device (10) can calculate the draft height with a smaller error as the vessel (80).

In the above explanation, the draft information generation device (10) showed a mode for calculating draft height at a certain time. However, by continuously calculating this draft height, the draft information generation device can also calculate the amount of change in draft height, etc.

In the above explanation, the draft information generation device (10) performs ranging for calculating the draft height at the time set by the device itself. However, for example, the information processor module may be equipped with an operation input interface, and when the operation input interface is operated to start calculation of draft height, the range-finding sensor may be controlled to perform ranging. A separate operation input interface (operation input device) may be provided to control the ranging of the range-finding sensor from the operation input interface.

In addition, in the above explanation, the draft information generation device (10) detects the frequency component and performed interpolation according to the frequency. However, the draft information generation device (10) may store in advance a state estimation model for proper interpolation and use this state estimation model to perform interpolation. For example, as a condition estimation model, a model based on the frequency of frequently occurring waves at the position where the vessel (80) measures draft height, a model based on weather information when the draft height is measured, etc., can be used. Linear interpolation is also available, but the draft height can be calculated more accurately by performing nonlinear interpolation.

Embodiments of the present disclosure may be modified in various ways within the scope of the claims.

### [Terminology]

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms) Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### DESCRIPTION OF REFERENCE CHARACTERS

10, 10A, 10B: Draft Information Generator Device

20: Multiple Range-Finding Sensors

20A: Range-Finding Sensor

21: Transmitter or Transmission Module

22: Receiver or Reception Module

23: Ranging Module

24: Communication Interface

29: Transmission/Reception Controller Module

30, 30A, 30B: Information Processor Module

31: Draft Information Generator (Processing Circuitry)

31B: Draft information Generator (Processing Circuitry)

32: Display

33: Communication Interface

41: Data Buffer

42: Data Selector or Data Selection Module

43: Frequency Component Detector or Frequency Component Module

44: Data Generator or Data Generation Module

45: Draft Height Calculator or Draft Height Calculation Module

50: Altitude Measurement Module

80: Vessel (Ship)

90: Sea (Water Body)

91: Water Surface

200: Transmission/Reception Surface

801: Ship Bottom (Bottom Shell Plate)

S11: Transmit and Receive Range-Finding Signal

S12: Select Data (Distance) Based on Signal Level

S13: Detect Frequency of Wave

S14: Generate Data for Calculating Draft Height

S15: Calculate Draft Height

What is claimed is:

1. A draft information generation device, comprising:
a range-finding sensor to be mounted on a side of a vessel configured to measure a distance to a water surface by transmitting a range-finding signal; and
processing circuitry configured to calculate a draft height based on the distance to the water surface.

2. The draft information generation device according to claim 1, further comprising:
a plurality of the range-finding sensors; wherein:
the plurality of range-finding sensors are mounted at different positions on the vessel.

3. The draft information generation device according to claim 2, wherein
the different positions of the vessel include a bow of the vessel, a stern of the vessel, and a longitudinal middle of the vessel.

4. The draft information generation device according to claim 1, wherein
the plurality of range-finding sensors are configured to measure the distance at multiple times; and
the processing circuitry is further configured to calculate the draft height using a statistical value of the distance measured at the multiple times.

5. The draft information generation device according to claim 4, wherein
the processing circuitry is further configured:
to select the distance measured at the multiple times based on the intensity of the range-finding signal; and
to execute a prescribed interpolation processing for the selected distance to generate data for calculation of the draft height consisting of distances arranged in time series.

6. The draft information generation device according to claim 5, wherein
the processing circuitry is further configured:
to detect a frequency component of the distance measured at the multiple times; and
to execute the interpolation processing using the frequency components.

7. The draft information generation device according to claim 2, wherein
the plurality of range-finding sensors are configured to measure the distance at multiple times; and
the processing circuitry is further configured to calculate the draft height using a statistical value of the distance measured at the multiple times.

8. The draft information generation device according to claim 7, wherein
the processing circuitry is further configured:
to select the distance measured at the multiple times based on the intensity of the range-finding signal; and
to execute a prescribed interpolation processing for the selected distance to generate data for calculation of the draft height consisting of distances arranged in time series.

9. The draft information generation device according to claim 8, wherein
the processing circuitry is further configured:
to detect a frequency component of the distance measured at the multiple times; and
to execute the interpolation processing using the frequency components.

10. The draft information generation device according to claim 3, wherein
the plurality of range-finding sensors are configured to measure the distance at multiple times; and
the processing circuitry is further configured to calculate the draft height using a statistical value of the distance measured at the multiple times.

11. The draft information generation device according to claim 10, wherein
the processing circuitry is further configured:
to select the distance measured at the multiple times based on the intensity of the range-finding signal; and
to execute a prescribed interpolation processing for the selected distance to generate data for calculation of the draft height consisting of distances arranged in time series.

12. The draft information generation device according to claim 11, wherein
the processing circuitry is further configured:
to detect a frequency component of the distance measured at the multiple times; and
to execute the interpolation processing using the frequency components.

13. A draft information generation method, comprising:
measuring a distance to a water surface from a predetermined position above the water surface of a hull by using a range-finding signal; and
calculating a draft height based on the distance to the water surface.

14. The draft information generation method according to claim 13, further comprising:
measuring the distance at different positions on the vessel.

15. The draft information generation method according to claim 14, wherein the different positions of the vessel include:
a bow of the vessel, a stern of the vessel, and a longitudinal middle of the vessel.

16. The draft information generation method according to claim 15, further comprising:
measuring the distance at multiple times; and
calculating the draft height using a statistical value of the distance measured at the multiple times.

17. The draft information generation method according to claim 16, further comprising:
selecting the distance measured at the multiple times based on the intensity of the range-finding signal; and
executing a prescribed interpolation processing for the selected distance to generate data for calculation of the draft height consisting of distances arranged in time series.

18. The draft information generation method according to claim 17, further comprising:
detecting a frequency component of the distance measured at the above multiple times; and
executing the interpolation processing using the frequency components.

19. A draft information generation program configured to cause a processing unit to execute processing, the processing comprising:
measuring a distance to a water surface from a predetermined position above the water surface of a hull by using a range-finding signal; and
calculating a draft height based on the distance to the water surface.

20. The draft information generation program according to claim 19, further comprising:
measuring the distance at different positions on the vessel.
